(19) United States
(12) Patent Application Publication
(10) Pub. No.: US 2026/0189847 A1
(43) Pub. Date: Jul. 2, 2026

(54) LOUDSPEAKER INCLUDING DUAL SPEAKER DRIVERS WITH CONJOINED PAIR OF ACOUSTIC TRANSMISSION LINES, AND VEHICLE STRUCTURE HAVING THE LOUDSPEAKER THEREIN

(71) Applicant: HARMAN INTERNATIONAL INDUSTRIES, INCORPORATED, Stamford, CT (US)

(72) Inventor: David Patrick SCHNEIDER, Bloomfield Hills, MI (US)

(73) Assignee: HARMAN INTERNATIONAL INDUSTRIES, INCORPORATED, Stamford, CT (US)

(21) Appl. No.: 19/431,386

(22) Filed: Dec. 23, 2025

Related U.S. Application Data
(60) Provisional application No. 63/739,922, filed on Dec. 30, 2024.

(51) Int. Cl. H04R 1/28; H04R 1/02; H04R 1/22

(52) U.S. Cl. CPC H04R 1/2857; H04R 1/025; H04R 1/227; H04R 1/288; H04R 2499/13

(57) ABSTRACT

A loudspeaker includes a speaker enclosure, first and second speaker drivers housed within the speaker enclosure, and first and second acoustic transmission lines housed within the speaker enclosure. The first and second acoustic transmission lines are respectively associated with the first and second speaker drivers and are a conjoined pair of acoustic transmission lines. The loudspeaker may be arranged within a structure of an assembly. The assembly may be a vehicle seat with the structure being a head rest or an upper portion of the vehicle seat.

### CROSS-REFERENCE TO RELATED APPLICATIONS

This application claims the benefit of U.S. Provisional Application No. 63/739,922, filed Dec. 30, 2024, the disclosure of which is hereby incorporated in its entirety by reference herein.

### TECHNICAL FIELD

The present disclosure relates to a vehicle structure, such as a vehicle seat headrest, having a loudspeaker therein for outputting audio for a person, such as a person sitting in the vehicle seat, to hear.

### BACKGROUND

A loudspeaker includes at least one speaker driver and a speaker enclosure. The speaker driver generates sound by moving air in response to an electrical signal. The speaker driver typically includes a diaphragm (cone), voice coil, magnet, and surround. The speaker driver is housed within the speaker enclosure. The speaker enclosure is a specially designed box or casing, typically made of wood or wood-based materials, that serves multiple purposes: it provides structural support, enhances sound reproduction by controlling the movement of air around the speaker driver, and helps with acoustics to produce more balanced or amplified sound. The speaker enclosure can be sealed (acoustic suspension), ported (bass reflex), or of other types, affecting the sound characteristics, such as bass response. Together, the speaker driver and the speaker enclosure work to produce audible sound from an electrical audio signal.

The loudspeaker may further have an acoustic transmission line within the speaker enclosure. The acoustic transmission line is a channel or pathway, typically made of wood or similar materials, designed to manage sound waves and resonance. In operation, when the speaker driver vibrates, the speaker driver generates sound waves in two directions: forward and backward (i.e., out of and into the speaker enclosure). The backward sound waves are directed into the acoustic transmission line, instead of being reflected randomly inside the speaker enclosure. Inside the pathway of the acoustic transmission line, the sound waves travel along the acoustic transmission line. The acoustic transmission line may be folded or tapered to increase its effective length while keeping the design compact. This controls the sound wave propagation and minimizes unwanted resonances or distortions. As the sound waves travel, the acoustic transmission line absorbs certain frequencies (typically higher ones) and reinforces others, often enhancing bass response. At the end of the acoustic transmission line, the remaining sound energy exits through an opening, usually called the port or terminus, of the acoustic transmission line. The exiting sound waves are designed to be in phase with the forward sound waves generated by the speaker driver, improving overall sound clarity and extending the bass frequency range. As set forth, in general, purposes of the acoustic transmission line include: bass enhancement—low-frequency sound waves are amplified by allowing them to resonate in the acoustic transmission line, creating deeper bass; noise reduction-by absorbing unwanted frequencies, distortion is reduced and the overall sound quality is improved; and efficient sound use—sound energy from the back of the speaker driver is not wasted but instead contributes constructively to the audio output.

A “Siamese” acoustic transmission line refers to a dual or coupled structure where two acoustic transmission lines share a common boundary or are interconnected in a symmetrical manner (i.e., a conjoined pair of acoustic transmission lines). That is, instead of having a single pathway, a Siamese configuration uses two parallel or interconnected pathways inside the speaker enclosure. The two pathways share a common area or are positioned close to one another, which allows them to influence each other's sound wave propagation. This is the “Siamese” part of the design, where the two pathways are connected or symmetrical. Sound waves traveling through these two pathways interact, especially at certain frequencies. The sound waves from each pathway can reinforce or cancel each other out, depending on their phase and the design of the transmission lines. The pathways can be positioned side by side, connected at certain points (like an internal “bridge”), or can be folded within the speaker enclosure, with each pathway winding through the speaker enclosure. The design and length of each pathway can vary, but both pathways work together to control the backward sound waves produced by the speaker driver.

### SUMMARY

An object of the present disclosure is a loudspeaker having a pair of speaker drivers and a conjoined pair of acoustic transmission lines housed within a speaker enclosure.

Another object of the present disclosure is a headrest or upper portion of a seat, such as a vehicle seat, having the loudspeaker therein.

A further object of the present disclosure is an instrument panel, such as of a vehicle, having the loudspeaker therein.

In carrying out at least one of the above and/or other objects, the present disclosure provides a loudspeaker. The loudspeaker includes a speaker enclosure, first and second speaker drivers housed within the speaker enclosure, and first and second acoustic transmission lines housed within the speaker enclosure. The first and second acoustic transmission lines are associated with the first and second speaker drivers, respectively, and are a conjoined pair of acoustic transmission lines.

The first speaker driver and the first acoustic transmission line may be housed within the speaker enclosure on a left side of the speaker enclosure, and the second speaker driver and the second acoustic transmission line may be housed within the speaker enclosure on a right side of the speaker enclosure.

The acoustic transmission lines terminate at a common exit port that opens out from the speaker enclosure. The common exit port may be between the left and right sides of the speaker enclosure.

The acoustic transmission lines may form the conjoined pair of acoustic transmission lines by sharing a common wall. The acoustic transmission lines may form the conjoined pair of acoustic transmission lines by being conjoined over their entire lengths in a vortex-type pattern.

The first acoustic transmission line may have a length that is about equal to a length of 1/4 of a wavelength of a resonance frequency of the first speaker driver, and the second acoustic transmission line may have a length that is about equal to a length of 1/4 of a wavelength of a resonance frequency of the second speaker driver.

The first acoustic transmission line may have a constant surface area that is about equal to an equivalent surface area of the first speaker driver, and the second acoustic transmission line may have a constant surface area that is about equal to an equivalent surface area of the second speaker driver.

The first acoustic transmission line has an entry area in immediate communication with the first speaker driver. The entry area of the first acoustic transmission line may be fluted to have a decreasing geometry as the entry area of the first acoustic transmission line extends away from the first speaker driver. The second acoustic transmission line has an entry area in immediate communication with the second speaker driver. The entry area of the second acoustic transmission line may be fluted to have a decreasing geometry as the entry area of the second acoustic transmission line extends away from the second speaker driver.

The first acoustic transmission line may include an acoustic filler material at an entrance and at an exit thereof. The second acoustic transmission line may include an acoustic filler material at an entrance and at an exit thereof.

The first and second speaker drivers may be identical speaker drivers having the same resonance frequency and the same equivalent surface area. The first and second acoustic transmission lines may each have a length that is about equal to a length of 1/4 of a wavelength of the resonance frequency. The first and second acoustic transmission lines may each have a constant surface area that is about equal to the equivalent surface area.

The first and second speaker drivers may be identical 3-inch speaker drivers having the same resonance frequency on the order of 100 Hz and the same equivalent surface area on the order of 7 square inches, the first and second acoustic transmission lines may each have a length on the order of 34 inches, and the first and second acoustic transmission lines may each have a constant surface area on the order of 7 square inches.

Further, in carrying out at least one of the above and/or other objects, the present disclosure provides an assembly. The assembly includes a structure and the loudspeaker.

The structure may be a head rest or an upper portion of a passenger seat of a vehicle. The structure may be an instrument panel of a vehicle.

The first speaker driver and the first acoustic transmission line may be housed within the speaker enclosure on a left side of the structure, and the second speaker driver and the second acoustic transmission line may be housed within the speaker enclosure on a right side of the structure. The first and second acoustic transmission lines terminate at a common exit port that opens out from the speaker enclosure. The common exit port may be between the left and right sides of the structure.

### BRIEF DESCRIPTION OF THE DRAWINGS

FIG. 1A illustrates a top view of a loudspeaker, with a top portion of a speaker enclosure of the loudspeaker being removed therefrom, in accordance with an exemplary first embodiment;

FIG. 1B illustrates a perspective view of the loudspeaker in accordance with the exemplary first embodiment;

FIG. 2A illustrates a top view of a loudspeaker, with a top portion of a speaker enclosure of the loudspeaker being removed therefrom, in accordance with an exemplary second embodiment; and

FIG. 2B illustrates a perspective view of the loudspeaker in accordance with the exemplary second embodiment.

### DETAILED DESCRIPTION

Detailed embodiments of the present disclosure are disclosed herein; however, it is to be understood that the disclosed embodiments are merely exemplary of the present disclosure that may be embodied in various and alternative forms. The figures are not necessarily to scale; some features may be exaggerated or minimized to show details of components. Therefore, specific structural and functional details disclosed herein are not to be interpreted as limiting, but merely as a representative basis for teaching one skilled in the art to variously employ the present disclosure.

Embodiments of the present disclosure pertain to a Siamesed acoustic transmission line (“SATL”) arrangement (i.e., conjoined pair of acoustic transmission lines) in which an application of acoustic transmission line technology is provided to extend frequency response when used with a pair of near field transducers (e.g., first and second speaker drivers) located in, for example, the head rest or upper portion of automotive passenger seats, or instrument panel, for purposes of providing full range sound with minimal cost, weight, and packing space. In addition to loudspeakers, the SATL arrangement is applicable to loudspeaker assemblies, loudspeaker sub-systems, and audio systems.

Known acoustic transmission line loudspeakers, i.e., those loudspeakers in which an acoustic transmission line is used in the speaker enclosure in lieu of a sealed enclosure or port, are usually selected for home or professional hi-fi system applications to provide a time aligned frequency response roll-off which also extends far below the resonance frequency of the speaker driver. The acoustic transmission line is generally associated with a single speaker driver and speaker enclosure, independent of other speaker enclosures or assemblies, and generally takes up a relatively large amount of space to accomplish its purpose.

Embodiments of the present disclosure use established (consumer/pro) technology in a new way in the automotive vehicle context, to optimize the output, response, cost, and packaging of a low-cost speaker system used in personal audio (vehicle seat-based) systems.

To realize an optimized package and weight (thus cost), and accomplish a target “full-range” bass response (e.g., extension down to ˜40 Hz, approximately ˜10 dB), the following parameters were selected and carefully applied by embodiments of the present disclosure:
(1) Small (3″) Extended Response Transducers (fs˜100 Hz)×2;
(2) ¼ wavelength transmission line×2 (˜34″ length)=the length of the transmission line is approximately equal to ¼ the wavelength of the resonance frequency of the speaker driver;
(3) constant surface area transmission line equal to the equivalent surface area of the transducers×2 (˜7 in₂ area);
(4) “Siamesed” transmission line geometry=transmission lines from both speaker drivers share one or more structural walls and/or acoustic spaces (e.g., outlet area);
(5) smooth transition—fluted or otherwise decreasing area input/output geometry of transmission line; and
(6) application of acoustically significant filler material at the front and rear 15% of the transmission line.

The above parameters are generally important to the optimization success for this application. That is, the combination of small transducers relative to the resonance frequency (e.g., effective surface area of the transducer is practically less than 8 square inches, with a resonance of 100 Hz or lower), the ¼ wavelength geometry and length of the transmission line, the constant surface area of the transmission line, the gradual transition from the transmission line to the speaker enclosure volume and outside volume, and the application of acoustic filler material.

The above notwithstanding, a chief contributor to the optimized application is the transmission line application in an automotive vehicle setting. This feature insures “full range” low frequency extension from speakers which would otherwise not extend more than a few Hz below their natural resonance. A primary contributor to the overall package optimization is the conjoined nature and speaker-specific geometry of the Siamesed transmission lines.

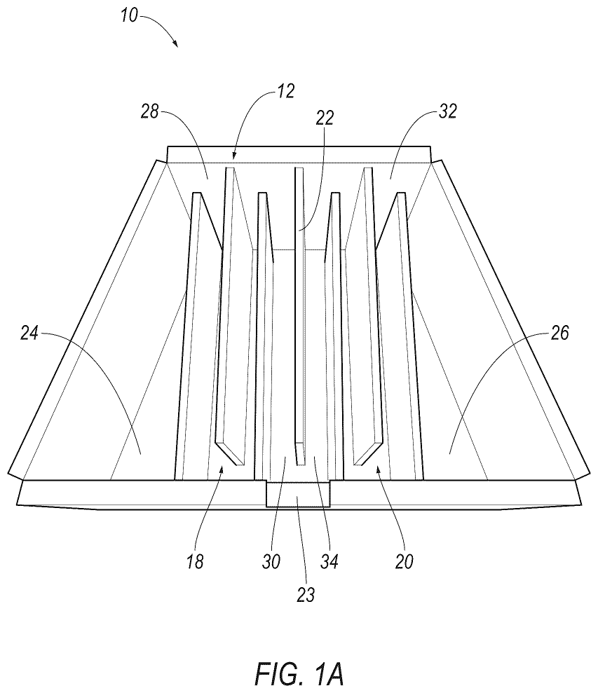

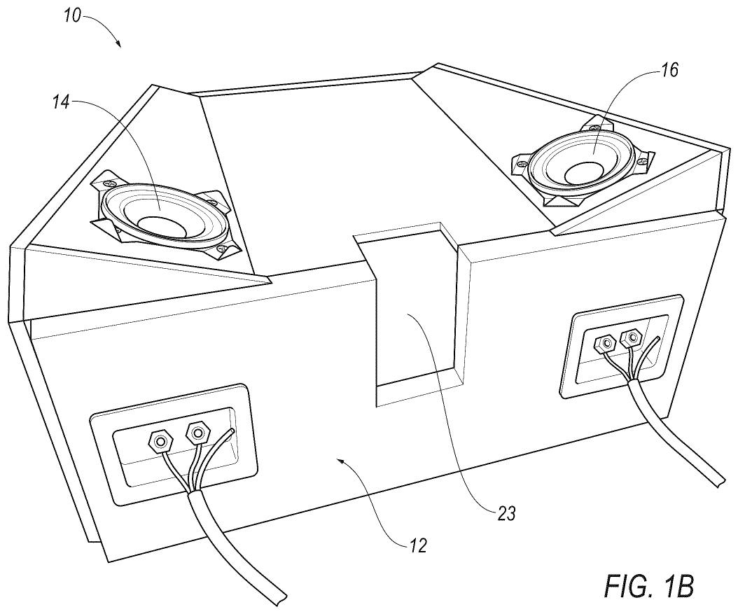

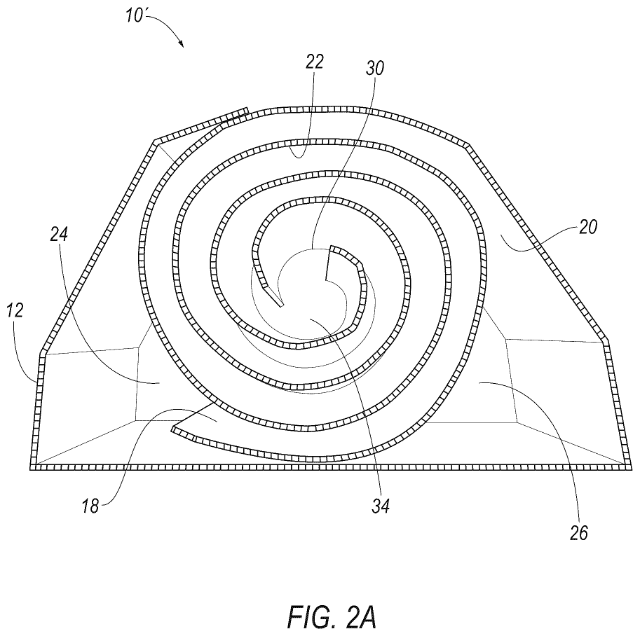

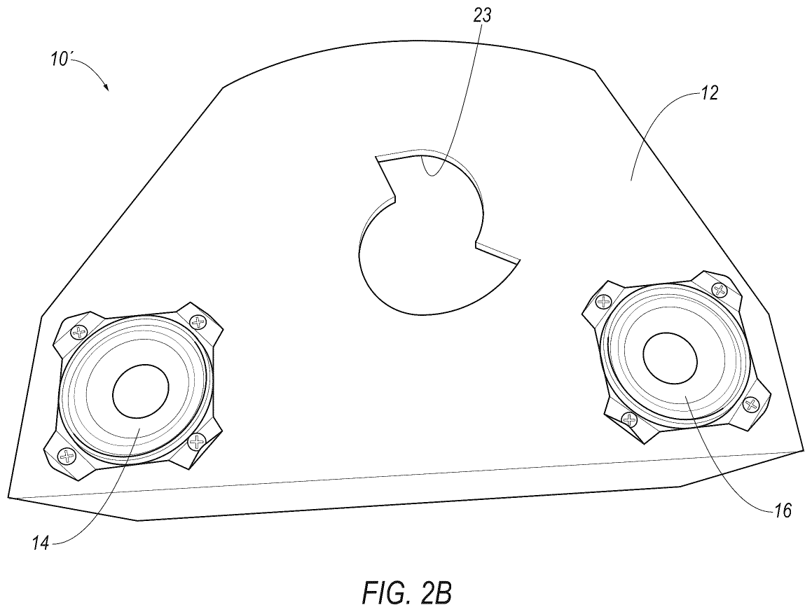

A loudspeaker pursuant to the concepts of the present disclosure can be configured in several embodiments. Two exemplary embodiments of a loudspeaker in accordance with the present disclosure will be described with reference to FIGS. 1A and 1B, which pertain to a first exemplary embodiment, and FIGS. 2A and 2B, which pertain to a second exemplary embodiment.

Referring now to FIGS. 1A and 1B, a loudspeaker 10 in accordance with the first exemplary embodiment will be described. FIG. 1A illustrates a top view of loudspeaker 10, with a top portion of a speaker enclosure 12 of the loudspeaker being removed therefrom. FIG. 1B illustrates a perspective view of loudspeaker 10.

In addition to speaker enclosure 12, loudspeaker 10 further includes first and second speaker drivers 14 and 16 and first and second acoustic transmission lines 18 and 20. Speaker drivers 14 and 16 and acoustic transmission lines 18 and 20 are housed within speaker enclosure 12. First acoustic transmission line 18 is associated with first speaker driver 14. Second acoustic transmission line 20 is associated with second speaker driver 16.

Speaker enclosure 12 may be made of wood or similar materials. Acoustic transmission lines 18 and 20 are pathways or channels that are formed by a set of walls within speaker enclosure 12. The walls forming acoustic transmission lines 18 and 20 may also be made of wood or similar materials. Acoustic transmission lines 18 and 20 are folded or the like along their lengths.

Acoustic transmission lines 18 and 20 are a conjoined pair of acoustic transmission lines. Acoustic transmission lines 18 and 20 form the conjoined pair of acoustic transmission lines by sharing a common wall 22.

First speaker driver 14 and first acoustic transmission line 18 are housed within speaker enclosure 12 on a left side of the speaker enclosure. Second speaker driver 16 and second acoustic transmission line 20 are housed within speaker enclosure 12 on a right side of the speaker enclosure.

Acoustic transmission lines 18 and 20 terminate at a common exit port 23 that opens out from speaker enclosure 12. Common exit port 23 is between the left and right sides of speaker enclosure 12. More particularly, common exit port 23 may be between first and second speaker drivers 14 and 16.

First acoustic transmission line 18 has an entry area 24 in immediate communication with first speaker driver 14. Entry area 24 of first acoustic transmission line 18 is fluted to have a decreasing geometry as entry area 24 extends away from first speaker driver 14. Likewise, second acoustic transmission line 20 has an entry area 26 in immediate communication with second speaker driver 16. Entry area 26 of second acoustic transmission line 20 is fluted to have a decreasing geometry as entry area 26 extends away from second speaker driver 16.

First acoustic transmission line 18 may have a length that is about equal to a length of 1/4 of a wavelength of a resonance frequency of first speaker driver 14. Likewise, second acoustic transmission line 20 has a length that is about equal to a length of 1/4 of a wavelength of a resonance frequency of second speaker driver 16.

First acoustic transmission line 18 may have a constant surface area that is about equal to an equivalent surface area of first speaker driver 14. Likewise, second acoustic transmission line 20 may have a constant surface area that is about equal to an equivalent surface area of second speaker driver 18.

First acoustic transmission line 18 may include an acoustic filler material (not shown) at an entrance 28 an at an exit 30 thereof. Likewise, second acoustic transmission line 20 may include an acoustic filler material (not shown) at an entrance 32 and at an exit 34 thereof.

In embodiments, speaker drivers 14 and 16 are identical speaker drivers having the same resonance frequency and the same equivalent surface area. Acoustic transmission lines 18 and 20 each have a length that is about equal to a length of ¼ of a wavelength of the resonance frequency. Acoustic transmission lines 18 and 20 each have a constant surface area that is about equal to the equivalent surface area.

In embodiments, speaker drivers 14 and 16 are identical 3-inch speaker drivers having the same resonance frequency on the order of 100 Hz and the same equivalent surface area on the order of 7 square inches. Acoustic transmission lines 18 and 20 each have a length on the order of 34 inches. Acoustic transmission lines 18 and 20 each have a constant surface area on the order of 7 square inches.

In further detail of the first exemplary embodiment, as shown in FIG. 1A, speaker drivers 14 and 16 (which are illustrated in FIG. 1B as being installed on either side of the loudspeaker assembly, in the lower part of the triangular volume) play into a decreasing area air passage. The decreasing area air passage associated with first speaker driver 14 transitions into the constant area acoustic transmission line 18. Acoustic transmission line 18 is folded along its length and has a length equal to ¼ of the wavelength frequency of first speaker driver 14. Likewise, the decreasing area air passage associated with second speaker driver 16 transitions into the constant area acoustic transmission line 20. Acoustic transmission line 20 is folded along its length and has a length equal to ¼ of the wavelength frequency of second speaker driver 16. The two acoustic transmission lines 18 and 20 (one right and one left, corresponding to each speaker driver 14 and 16) share common wall 22 and common exit port 23 and are thus “Siamese” twins or “Siamsed”.

As indicated in FIG. 1B, in the first exemplary embodiment, speaker drivers 14 and 16 are tilted to be directed toward a person's ears (not shown) (the person's head would be approximately aligned with the midpoint of the speaker drivers in the Y-axis (e.g., up/down in a vehicle) and between the speaker drivers in the X-axis (e.g., cross-vehicle) with the person sitting in front of and facing away from speaker enclosure 12 as pictured in FIG. 1B).

In addition to a beneficial effect of angling speaker drivers 14 and 16 to be more on-axis to the listener person, the first exemplary embodiment exaggerates the smooth transition from speaker enclosure 12 to each acoustic transmission line 18 and 20 by decreasing the volume gradually in three dimensions.

Acoustic batting is also present inside speaker enclosure 12 in the transition areas and along the first 15% or so of the front and exit of each acoustic transmission line 18 and 20. This exaggerates the transition and reduces noise without significantly distorting the rest of the desired cavity effects of acoustic transmission lines 18 and 20.

Referring now to FIGS. 2A and 2B, loudspeaker 10′ in accordance with the second exemplary embodiment will be described. Loudspeaker 10′ includes same types of components as loudspeaker 10 and the reference numerals are used to designate such common components. FIG. 2A illustrates a top view of loudspeaker 10′, with a top portion of speaker enclosure 12 being removed therefrom. FIG. 2B illustrates a perspective view of loudspeaker 10′.

In loudspeaker 10′, first and second acoustic transmission lines 18 and 20 form the conjoined pair of acoustic transmission lines by being conjoined over their entire lengths in a vortex-type pattern, as shown in FIG. 2A.

In further detail of the second exemplary embodiment, speaker drivers 14 and 16 are once again located in lower corners of speaker enclosure 12. However, in this embodiment, the two acoustic transmission lines 18 and 20 are “Siamesed” along their entire length in a vortex-type pattern.

The decreasing spiral configuration of acoustic transmission lines 18 and 20 may have several advantages. One advantage may be the use of less wall stock/material (size, cost, weight reduction) as acoustic transmission lines 18 and 20 share the same common wall 22 over their entire length. Another advantage may be inherently smoother air flow and consistent area and volume over the entire length of each acoustic transmission line 18 and 20 due to the continuous geometry (the absence of back and forth and no corners translates into no increased volume in square bends, less energy lost, less turbulence, and less noise). Another advantage may be natural fluting effect of the entry/exit areas of acoustic transmission lines 18 and 20.

As the first and second exemplary embodiments of a loudspeaker show, slight changes in the geometry of the loudspeaker may be realized, rearranged, or packaged to accommodate integration of the loudspeaker into a structure, such as an automotive headrest, seatback, or instrument panel, such that the speaker drivers (i.e., transducers) themselves are pointing toward a listener person, or for other constraints. For personal audio applications, common exit port 23 of acoustic transmission lines 18 and 20 termination should be oriented to excite air in the direction of the listener person's body (and not toward other listener persons).

As described, a loudspeaker in accordance with the present disclosure is intended to solve the problem of achieving full range low frequency sound from a minimal set (stereo pair) of relatively inexpensive transducers in a minimal package space with a minimal weight. The “SATL” design of a loudspeaker in accordance with the present disclosure saves package space, weight, and cost relative to current known solutions, while enabling full range audio extension from an inexpensive stereo pair of otherwise limited bandwidth transducers. Similar extension without the use of SATL would require a dedicated woofer and enclosure (additional cost, package, weight, wiring, and amplifier channel) or larger transducers for the stereo pair (e.g., 4-6.5 inches speaker drivers), which are generally larger, cost more, and are not conducive to similarly constrained packaging applications (headrest, seat back, or instrument panel).

While exemplary embodiments are described above, it is not intended that these embodiments describe all possible forms of the present disclosure. Rather, the words used in the specification are words of description rather than limitation, and it is understood that various changes may be made without departing from the spirit and scope of the present disclosure. Additionally, the features of various implementing embodiments may be combined to form further embodiments of the present disclosure.

What is claimed is:

1. A loudspeaker comprising:
a speaker enclosure;
first and second speaker drivers housed within the speaker enclosure; and
first and second acoustic transmission lines housed within the speaker enclosure, the first and second acoustic transmission lines being associated with the first and second speaker drivers, respectively, and being a conjoined pair of acoustic transmission lines.

2. The loudspeaker of claim 1 wherein:
the first speaker driver and the first acoustic transmission line are housed within the speaker enclosure on a left side of the speaker enclosure, and the second speaker driver and the second acoustic transmission line are housed within the speaker enclosure on a right side of the speaker enclosure.

3. The loudspeaker of claim 2 wherein:
the first and second acoustic transmission lines terminate at a common exit port that opens out from the speaker enclosure, the common exit port being between the left and right sides of the speaker enclosure.

4. The loudspeaker of claim 1 wherein:
the first and second acoustic transmission lines form the conjoined pair of acoustic transmission lines by sharing a common wall.

5. The loudspeaker of claim 1 wherein:
the first and second acoustic transmission lines form the conjoined pair of acoustic transmission lines by being conjoined over their entire lengths in a vortex-type pattern.

6. The loudspeaker of claim 1 wherein:
the first acoustic transmission line has a length that is about equal to a length of ¼ of a wavelength of a resonance frequency of the first speaker driver; and
the second acoustic transmission line has a length that is about equal to a length of ¼ of a wavelength of a resonance frequency of the second speaker driver.

7. The loudspeaker of claim 1 wherein:
the first acoustic transmission line has a constant surface area that is about equal to an equivalent surface area of the first speaker driver; and
the second acoustic transmission line has a constant surface area that is about equal to an equivalent surface area of the second speaker driver.

8. The loudspeaker of claim 1 wherein:
the first acoustic transmission line has an entry area in immediate communication with the first speaker driver, the entry area of the first acoustic transmission line being fluted to have a decreasing geometry as the entry area of the first acoustic transmission line extends away from the first speaker driver; and
the second acoustic transmission line has an entry area in immediate communication with the second speaker driver, the entry area of the second acoustic transmission line being fluted to have a decreasing geometry as the entry area of the second acoustic transmission line extends away from the second speaker driver.

9. The loudspeaker of claim 1 wherein:
the first acoustic transmission line includes an acoustic filler material at an entrance and at an exit thereof; and
the second acoustic transmission line includes an acoustic filler material at an entrance and at an exit thereof.

10. The loudspeaker of claim 1 wherein:
the first and second speaker drivers are identical speaker drivers having the same resonance frequency and the same equivalent surface area.

11. The loudspeaker of claim 10 wherein:
the first and second acoustic transmission lines each have a length that is about equal to a length of ¼ of a wavelength of the resonance frequency.

12. The loudspeaker of claim 10 wherein:
the first and second acoustic transmission lines each have a constant surface area that is about equal to the equivalent surface area.

13. The loudspeaker of claim 1 wherein:
the first and second speaker drivers are identical 3-inch speaker drivers having the same resonance frequency on the order of 100 Hz and the same equivalent surface area on the order of 7 square inches;
the first and second acoustic transmission lines each have a length on the order of inches; and
the first and second acoustic transmission lines each have a constant surface area on the order of 7 square inches.

14. An assembly comprising:
a structure; and
a loudspeaker arranged within the structure, the loudspeaker having a speaker enclosure, first and second speaker drivers housed within the speaker enclosure, and first and second acoustic transmission lines housed within the speaker enclosure, and the first and second acoustic transmission lines being associated with the first and second speaker drivers, respectively, and being a conjoined pair of acoustic transmission lines.

15. The assembly of claim 14 wherein:
the structure is a head rest of a passenger seat of a vehicle.

16. The assembly of claim 14 wherein:
the structure is an upper portion of a passenger seat of a vehicle.

17. The assembly of claim 14 wherein:
the structure is an instrument panel of a vehicle.

18. The assembly of claim 14 wherein:
the first speaker driver and the first acoustic transmission line are housed within the speaker enclosure on a left side of the structure, and the second speaker driver and the second acoustic transmission line are housed within the speaker enclosure on a right side of the structure.

19. The assembly of claim 18 wherein:
the first and second acoustic transmission lines terminate at a common exit port that opens out from the speaker enclosure, the common exit port being between the left and right sides of the structure.

20. The assembly of claim 14 wherein:
the first and second speaker drivers are identical speaker drivers having the same resonance frequency and the same equivalent surface area;
the first and second acoustic transmission lines each have a length that is about equal to a length of ¼ of a wavelength of the resonance frequency; and
the first and second acoustic transmission lines each have a constant surface area that is about equal to the equivalent surface area.
